(19) United States
(12) Patent Application Publication
(10) Pub. No.: US 2002/0136207 A1
(43) Pub. Date: Sep. 26, 2002

(54) Packet switch and packet memory access method therefor

(75) Inventors: Yoshimitsu Matsumoto, Tokyo (JP); Manabu Chousa, Fukuoka (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/100,029

(22) Filed: Mar. 19, 2002

(30) Foreign Application Priority Data
Mar. 21, 2001 (JP) 2001-79649

(51) Int. Cl. H04L 12/28

(52) U.S. Cl. 370/352; 370/351

(57) ABSTRACT

A line processing module 3 performs processes such as protocol identification, label processing for an associated protocol and in-device address translation for each line. Packet data is stored in a packet memory 5 through high-speed interface macros 2a and 2b based on the in-device address information obtained in the line processing module 3. The in-device address information for all lines is indicated to a scheduler 4 and the scheduler 4 performs scheduling based on the indicated address information. Buffer management if performed for each link and the packet data is read from the packet memory 5 through the high-speed interface macros 2a and 2b. The read packet data is switched in a cross-point switch 6 according to directions from the scheduler 4 and sent back to the line processing module 3, then sent to an output line. Thus, a packet switch can be provided that can expand high-speed access to the packet memory, increase the speed of lines and line processing module without increasing the number of terminals.

### BACKGROUND OF THE INVENTION

1. Field of the Invention

The present invention relates to a packet switch and packet memory access method therefor, and more specifically, to a packet switch used in a switching system for processing a vast amount of traffic and packet memory access method therefor.

2. Description of the Related Art

Recently, the throughput of a system has been on the increase with an increase in line speed and the number of communication lines. The need to develop a switching system for processing a vast amount of traffic has become urgent. Another recent trend is to provide a line capacity allowing for a traffic burst, which often occurs on a network such as the Internet.

In order to prevent blocking of packet data sent from a number of lines in a packet switch, a buffer (packet memory) for temporarily holding the packet data is required for the switching system. The challenge for developers is to improve buffer capacity and buffer access processing in increasingly large switches.

Various switching methods for switches have been proposed. To address the larger scale switches, an input buffer method is most feasible as a buffer accessing method. This is because the input buffer method requires lower throughput of an input buffer than that in other methods.

Although the input buffer method is somewhat advantageous compared with other methods, improvement in buffer access speed and buffer capacity will become hurdles to be overcome in constructing a larger scale switch.

In today's switch market, providing higher bandwidths of access lines is not enough to address the increasing traffic. There is a demand for higher channel speeds and larger capacities of the access lines. They should be directly reflected in input buffer access speed.

Given that burst traffic packet data is input to a particular output line from all available input lines at the same moment, it is required that a buffer having a considerably large capacity be provided in order to achieve a configuration that can adequately handle packet discard. Required buffer capacity increases in proportion to an increase in the number of lines or in line speed.

Major functions of a preprocessing module of a switch include complicated functions such as frame termination, identification of protocols, generation, addition, and deletion of a switch (in-device) packet header (an output route, class, and broadcast identification), conversion of various protocol packets into in-device packets, and buffer control by scheduling based on the packet header information. Accordingly, the scale of this section should be considerably large.

Given the above-described upsizing of the prior-art switch, and with the current state of the art, it is impossible in terms of size to provide the line processing module described above and a buffer for storing packets on one chip, even if improvement in the performance of devices can be expected.

Because of the above-mentioned constraint, the line processing module, a memory controller module, and scheduler, external memory (buffer) should be provided on separate chips. As the external memory, typically a general-purpose memory module such as a DIMM (Dual In-line Memory Module) is used.

The access speeds of external memory devices are not keeping up with line speeds, which are rapidly becoming faster from year to year. As aresult, there is no other choice but to use parallel processing. As an inevitable consequence, the number of terminals is increasing. The access speed of today's fast external memory is at most several hundred MHz. To accommodate packets transmitted at a line speed of several tens or hundreds Gbps, several hundred to several thousand terminals would be required.

The increase in the line speeds and the number of lines would result in a further increase in required buffer capacity, and therefore, the number of external memory devices. As a result, the number of terminals would further increase. This would result in a larger hardware scale for parallel processing and an increased number of package layers in implementation, which impairs the scalability of the switch.

In addition, if external memory devices operating at an access speed of several hundreds MHz are accessed in parallel, data transmission using clock synchronization is performed. Therefore, it is required that precise equal-length wiring of data signal lines be achieve in order to minimize delay variations (skews) among the data signal lines in a transmission channel that can cause the phase difference between a data signal and clock signal. Furthermore, the length of each data signal line is limited to a short length in order to prevent a phenomenon (crosstalk) in which voltages on different data signal lines affects one another.

### SUMMARY OF THE INVENTION

It is an object of the present invention to provide a packet switch and a packet memory access method used with the packet switch that enable faster access to packet memory and can enhance the speed of aline and line processing module without increasing the number of terminals.

The packet switch according to the present invention stores packet data in a packet memory for each individual output link on an input-line basis and transfers the packet data from the packet memory to a lower loaded output link. The packet switch comprises line processing unit for translating the in-device address of the packet data to obtain at least read/write control signals for the packet memory and a first high-speed interface unit provided in the packet memory and the line processing unit for sending/receiving at least the packet data at high speed. The packet switch is configured so as to store the packet data in the packet memory through the first high-speed interface unit based on the read/write control signals obtained in the line processing unit.

The packet memory access method according to the present invention stores packet data in a packet memory for each individual output link on an input-line basis and transfers the packet data from the packet memory to a lower loaded output link. The packet memory access method comprises the steps of: translating the in-device address of the packet data to obtain at least read/write control signals for the packet memory; and storing the packet data in the packet memory through a first high-speed interface unit for sending/receiving at least the packet data based on the read/write control signals.

### BRIEF DESCRIPTION OF THE DRAWINGS

The above and other objects, features, and advantages of the present invention will become more apparent from the following detailed description when taken in conjunction with the accompanying drawings wherein:

FIG. 1 is a block diagram showing a configuration of apacket switch according to a first embodiment of the present invention;

FIG. 2 is a block diagram showing configuration of a high-speed interface shown in FIG. 1;

FIG. 3 is a block diagram showing a configuration of a line processing module shown in FIG. 1;

FIG. 4 is a block diagram showing a configuration of packet memory shown in FIG. 1;

FIG. 5 is a block diagram showing a configuration of a memory controller shown in FIG. 4;

FIG. 6a shows an upstream transmission data format according to the first embodiment of the present invention;

FIG. 6b shows a downstream transmission data format according to the first embodiment of the present invention;

FIG. 7 is a flowchart of acontrol flow in an entire apparatus according to the first embodiment of the present invention;

FIG. 8 is a flow chart of a control flow in the entire apparatus according to the first embodiment of the present invention;

FIG. 9 is a flowchart of an internal operation of the packet memory according to the first embodiment of the present invention;

FIG. 10 is a flowchart of an internal operation of the packet memory according to the first embodiment of the present invention;

FIG. 11 is a block diagram showing a configuration of a packet switch according to a second embodiment of the present invention;

FIG. 12 is a block diagram showing a configuration a packet switch according to a third embodiment of the present invention; and

FIG. 13 is a block diagram showing a configuration of a packet switch according to a fourth embodiment of the present invention.

### DETAILED DESCRIPTION OF THE PREFERRED EMBODIMENTS

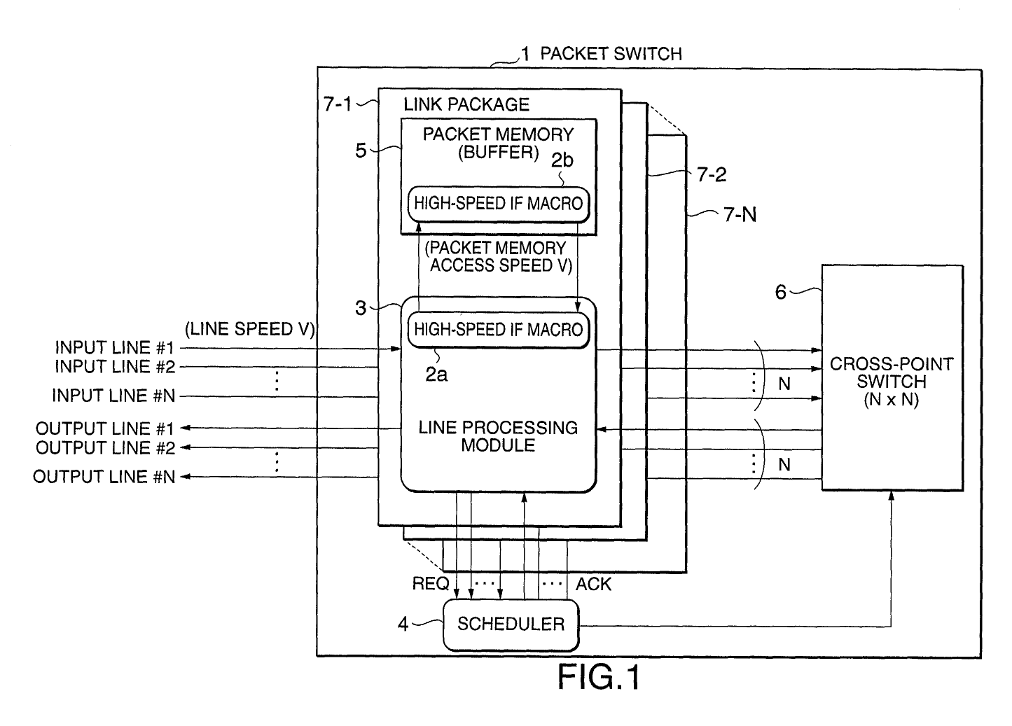

A packet switch and a packet memory access method used with the packet switch will be described with reference to FIGS. 1 through 13.

FIG. 1 shows a block diagram of a configuration of a packet switch according to a first embodiment of the present invention. The packet switch 1 in FIG. 1 comprises line packages 7-1 through 7-N (N is a positive integer), each of which is provided for each individual line and contains a line processing module 3 and packet memory (buffer) 5, a scheduler 4, and a cross-point switch (N×N) 6. The line processing module 3 and the packet memory 5 are provided on separate chips and contain high-speed interface macros (hereinafter called “high-speed IF macros”) 2a and 2b.

In recent years, in the GHz class access using a serial interface, high-speed interface circuits including a phase adjustment function using a method such as CDR (Clock and Data recovery) have been released from a number of manufacturers. Such a high-speed interface circuit eliminates the need for considering the phase difference between data and a clock. Because waveform deterioration of high-frequency waves has been reduced thanks to the recent advances in device technology and measures against transmission line attenuation, a relatively long connection distance can be provided. That is, a serial interface is suitable for fast, long-distance data transmission compared with a parallel interface, which uses a plurality of signal lines. Therefore, serial interfaces are used for the above-mentioned high-speed IF macros 2a and 2b.

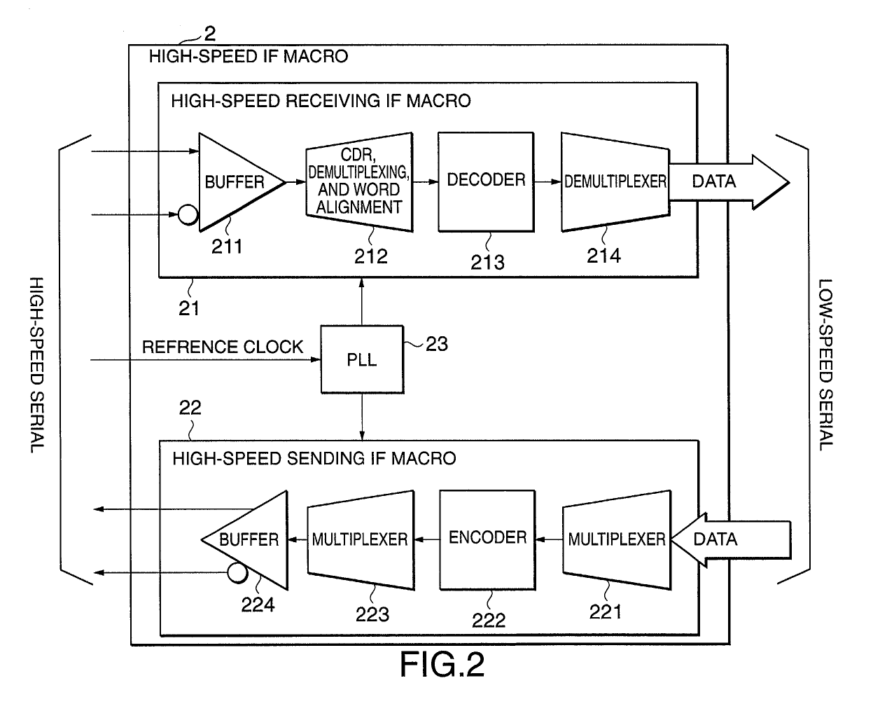

FIG. 2 shows a block diagram of a configuration of the high-speed interface macros 2a and 2b. Each of the high-speed IF macros 2a and 2b (collectively called “high-speed IF macro 2”) in FIG. 2 consists of a high-speed receiving interface macro (hereinafter called “high-speed receiving IF macro”) 21, a high-speed sending interface macro (hereinafter called “high-speed sending IF macro”) 22, anda PLL (Phase Locked Loop) circuit 23.

The high-speed receiving IF macro 21 consists of an input buffer 211, a CDR (Clock and Data Recovery), demultiplexing (DEMUX), and word-alignment module 212, decoder module 213, and a demultiplexer 2l4. The high-speed-sending IF macro 22 consists of amultiplexers 221 and 223, a encoder 222, and an output buffer 224.

Serial data input from a high-speed serial link into the high-speed receiving IF macro 21 is provided to a low-speed parallel link as parallel data through the input buffer 221, CDR, demultiplexing and word-alignment module 212, the decoder 213, and the demultiplexer 214. Parallel data input from the low-speed parallel link into the high-speed IF macro 22 is provided to the high-speed serial link as serial data through the multiplexer 221, encoder 222, multiplexer 223, and output buffer 224. While the demultiplexer 214 and multiplexer 221 are provided in this embodiment, the provision of them may vary depending on the specifications for the low-speed parallel link.

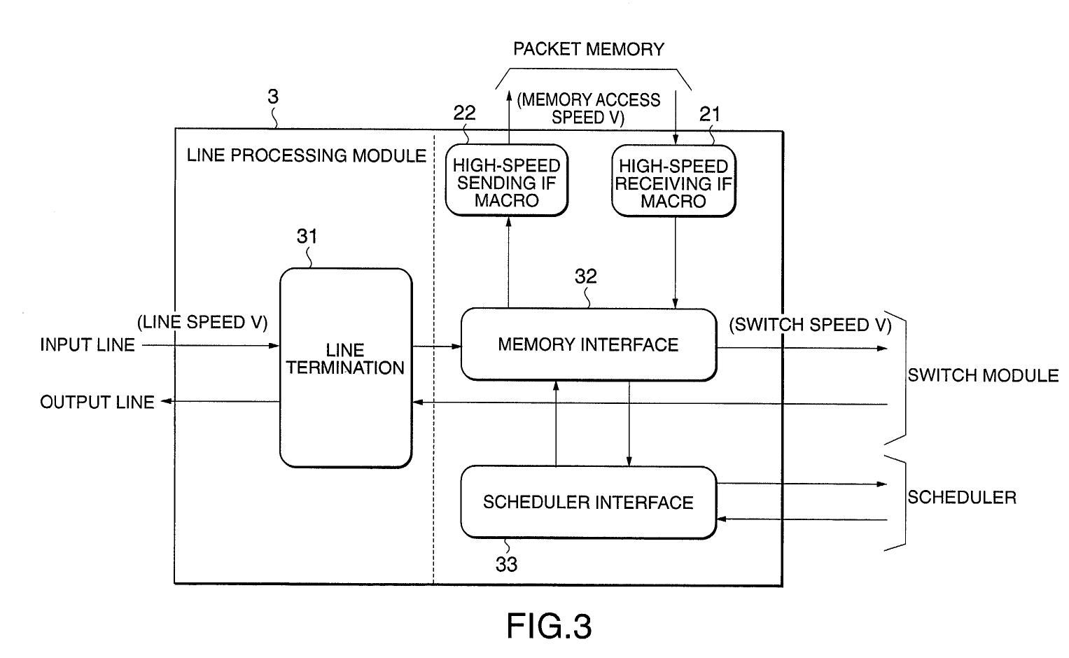

FIG. 3 shows a block diagram of a configuration of the line processing module 3 in FIG. 1. The line processing module 3 shown in FIG. 3 consists of a line termination section 31, a memory interface module 32, a scheduler interface module 33, a high-speed sending IF macro 22, and a high-speed receiving IF macro 21.

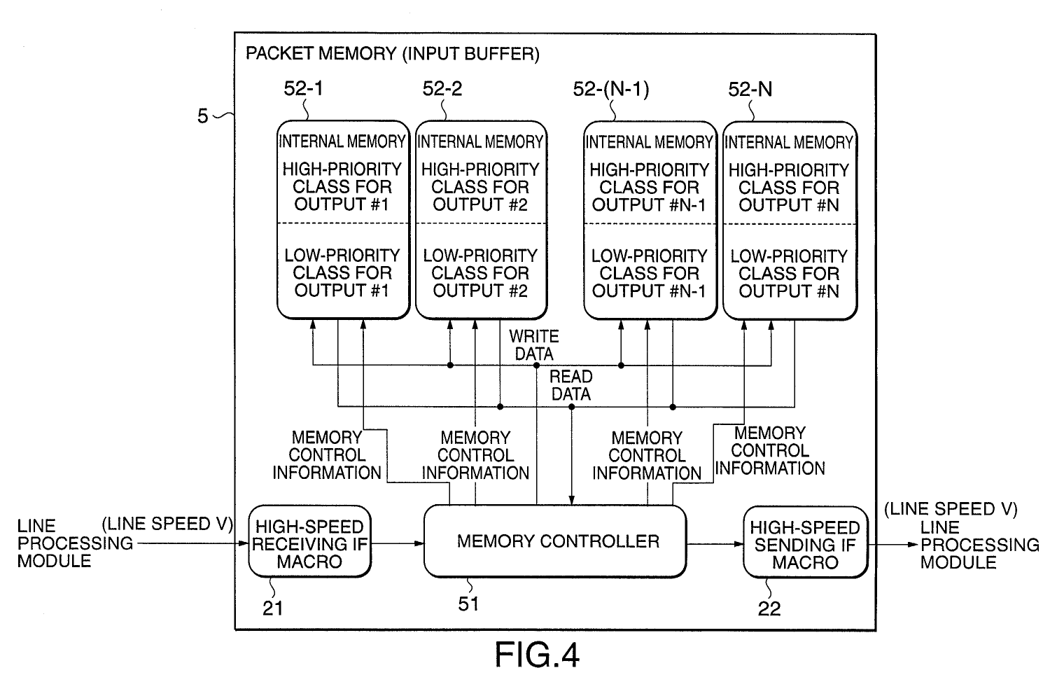

FIG. 4 shows a block diagram of a configuration of the packet memory 5 shown in FIG. 1. The packet memory 5 in FIG. 4 consists of the high-speed receiving macro 21, a memory controller 51, internal memories 52-1 through 52-N, and the high-speed sending IF macro 22.

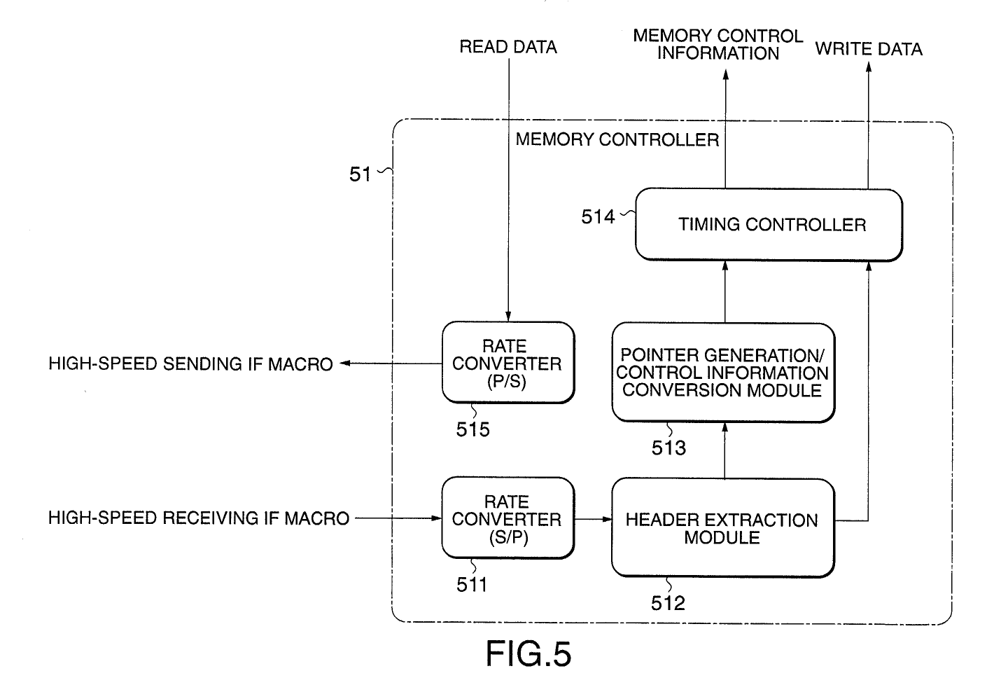

FIG. 5 shows a block diagram of a configuration of the memory controller 51 shown in FIG. 4. The memory controller 51 in FIG. 5 consists of a rate (S/P: serial-to-parallel) converter 511, a header extraction module 512, a pointer generation/control information conversion module 513, a timing controller 514, and a rate (P/S: parallel-to-serial) converter 515.

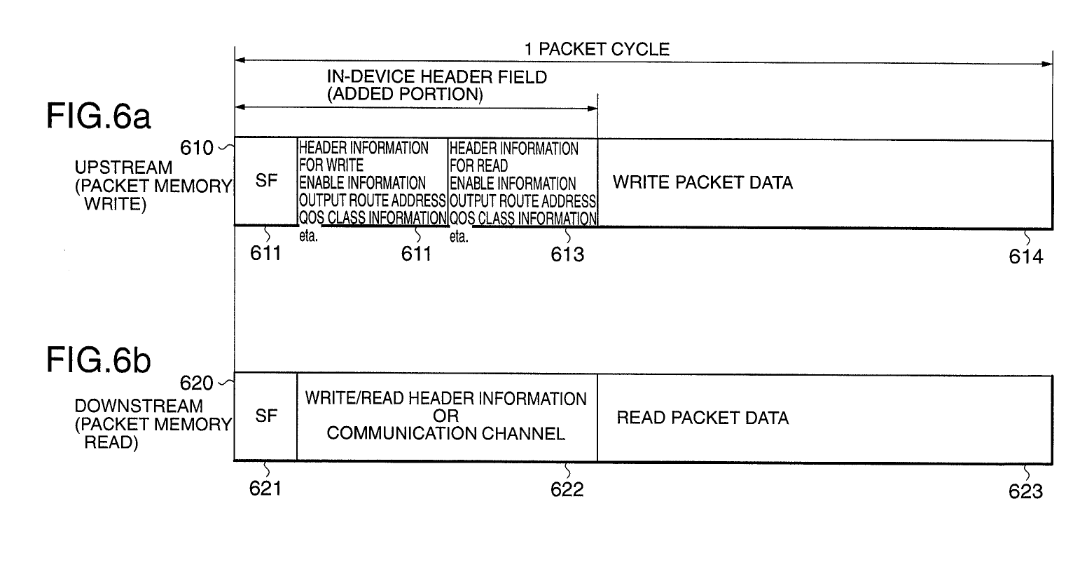

FIG. 6 shows an exemplary format of transmission data according to the first embodiment of the present invention. FIG. 6a shows a transmission data format 610 for upstream and FIG. 6b shows a transmission data format 620 for downstream The transmission data format 610 consists of a Start Frame (SF) 611, enable information, an output routing address, write header information 612 and read header information 613 including information such as Quality of Service (QoS) class information, and write packet data 614.

The transmission data format 620 consists of an SF 621, write/read header (or communication channel) information 622, and read packet data 623.

The exemplary configuration of the switch according to the first embodiment of the present invention shown in FIG. 1 will be described first with reference to FIGS. 2 through 6. In the input-buffer-based packet switch 1, packets provided from individual lines #1 through #N using different protocols are first input in a line termination section 31 of the line processing module 3. In the line termination section 31, termination for a frame is performed for each line. That is, termination processes such as identification of individual protocols, label processing according to an associated protocol, in-device address translation, conversion from packets conforming to different protocols to in-device fixed-length packets, and head information assortment associated with the conversion.

Depending on protocols, variable-length packet data the amount of which vary within a certain range may be received. Dividing the packet data into fixed length data and then processing the data enable cyclic band management, allowing simplified control, efficient access to the packet memory 5, and smooth operation of the cross-point switch 6 in the device.

After the in-device address translation is performed, the address information is inserted in the write header field of the fixed-length transmission data format 610 data as control information about a write to the packet memory 5, then sent to the memory interface module 32. The address information is also sent to the scheduler interface module 33 separately.

Provided in the scheduler interface module 33 is a counter (not shown) for monitoring the number of packets held in each of buffers separated by class of the individual output routes. If it is determined based on the counter value that packets are accumulated, information (a request) indicating that accumulation is provided to the scheduler 4. The scheduler 4 performs priority control for each output route based on the request information provided from the line processing module 3 of all the input lines #1 through #N to cause themost appropriate packet to be sent out. The counter for counting the number of packets held in the buffer may be provided in the scheduler 4 to centralize the held packet counting for all the input lines.

However, in such a case, the scheduler 4 must performs a series of processes such as valid packet recognition, held packet monitoring, and scheduling calculations in time sequence within one packet cycle (one packet cycle is a time period equivalent to one packet time period or the shortest packet length), which would add to scheduling calculation time. In this embodiment therefore, the counters monitoring packets held in the buffers are distributed in each of the individual line processing modules 3 for each of the individual input lines #1 through #N.

This is advantageous in that the proportion of time for calculation by the scheduler in one packet cycle can be increased. The scheduler 4 also performs flow control for each QoS class. The QoS classes can be broadly divided into two: a group of high-priority classes that assures the quality of delay and packet discard rate and a group of low-priority classes that does not assure the quality of them. Traffic of a low-priority class may suffer waiting time during which it should wait the completion of transmission of traffic of a high-priority class before being transmitted. With the current state of the art, traffic in several classes from both of the high-priority and low priority groups are typically handled together.

Address information obtained from the scheduler 4 is sent back to the scheduler interface module 33. Whether the count value of the stored-packet counter should be incremented or decremented is determined based on this information. This information is sent to the memory interface module 32 and inserted into the read header field of the packet 610 sent from the line termination module 31 as control information about a read from the packet memory 5.

The speed of the packet data 610 to which control information for write and read is added in this way is converted into a speed compatible with the high-speed sending IF macro 22 and sent to the high-speed sending IF macro 22. In this embodiment, several hundred signals at speeds of several hundred Mbps are converted into several serial signals at speeds of several Gbps.

If packet data transmitted from the line processing module 3 at a line speed of 40 Gbps or higher accesses a packet memory 5 that is a state-of-the-art external memory such as a general-purpose DIMM (the maximum processing speed is several to 200 MHz), for example, more than 200 terminals would be required.

On the other hand, in the packet memory 5 including the high-speed receiving IF macro 21 and high-speed sending IF macro 22, the number of terminals can be reduced to only 20, assuming that 2 Gbps data can be processed in one channel, for example. That is, the number of terminals can be reduced by a factor of ten or more. The number of interfaces between chips can be reduced and, in addition, a large amount of data canbe transmitted by using such a high-speed sending/receiving interface circuit in each of the line processing module 3 and packet memory 5 provided on separate chips.

The packet data thus converted into high-speed serial data in the high-speed sending IF macro 22 of the line processing module 3 is transferred to the high-speed receiving IF macro 21 in the packet memory 5.

Various specifications and configurations for a high-speed receiving IF macro 21 are provided by a number of manufacturers. A typical high-speed receiving IF macro includes a CDR (Clock and Data Recovery) function provided by combining a VCO (Voltage Control Oscillator), PD (Phase Detector), charge pump, and low-pass filter. An error signal detected by the PD is fed back to the VCO through the charge pump and low-pass filter.

A signal requiring adjustment detected by a component such as frequency detector (FD) is also sent to the VCO and phase adjustment is achieved by voltage control in the VOC to obtain an optimum clock and latch the data. Then, the packet data is parallelized and sent to the memory controller 51. If the packet data does not fit into one channel because of an enlarged line capacity and is transmitted over a number of channels, the data in the channels should be brought into synchronization with each other by the high-speed receiving IF macro 21.

The speed of the packet data received at the rate converter 511 in the memory controller 51 is converted into a speed suitable for accessing memory. Then the header extracting module 512 extracts the header information included in the packet data. Data extracted on the writing side includes an output route address, class information for each output route, and an enable signal indicating whether the packet is valid or invalid. Data extracted in the reading side includes control information (as with the writing side, an output route address, class information for each output route, read enable signal, and the like) coordinated by the scheduler 4.

The packet data from which the header is extracted is directly sent to the timing controller 514. The pointer generation/control information conversion module 513 performs processes such as decoding based on the extracted control information to generate a pointer to one of the internal memories (input buffer) 52-1 through 52-N, a write/read enable signal, and a memory select signal. The pointer to the internal memories 52-1 through 520N can be constructed by using components such as a counter. That is, a write address counter and read address counter are provided for each output route/class.

The internal memories 52-1 through 52-N are FIFO (First In First Out) memories. Therefore, if it is determined that a packet is going to be written to any of the internal memories 52-1 though 52-N, the write address counter is incremented. If it is determined that a packet is going to be read, the read address counter is incremented. If it is determined that no packet is held in the internal memories 52-1 through 52-N and write/read control is not performed, the pointer is cleared.

Various control signals thus obtained are sent to the timing controller 514. After the timing of sending the packet data is matched and format conversion for memory access is performed according to control information about the write to any of the internal memories 52-1 through 52-N, the various control signals are sent to that one of the internal memory 52-1 through 52-N.

The internal memories 52-1 through 52-N are divided for individual output routes and further separated by QoS class for each of the output routes. The memories may logically or physically divided according to their capacity, and may possibly be provided on separate chips. Each of the separated internal memories 52-1 through 52-N is compatible with memory access signals generated through the above-described process and the signals can easily be buffered.

Write operation to the internal memories 52-1 through 52-N is performed based on the packet data formatted for the internal memories 52-1 through 52-N and the write control information. Read operation from the internal memories 52-1 through 520N is performed also based on the above-mentioned read control signal.

Typical architecture of the internal memories 52-1 through 52-N is I/O (input/output)—separate memory such as single-port RAM (Random Access Memories) and a dual-port RAM. Dual-port RAM is used in this embodiment.

If single-port RAM were used, it would be required that write and read of one packet of data be handled sequentially (in a time division manner) in one packet time period during packet transmission. There fore a memory access speed two times faster than line speed would be required and two extra rate conversion circuits and an extra format conversion circuit must be added. In addition, in some high-speed interface circuits, the number of terminals would be increased for parallel processing.

On the other hand, if dual-port RAM is used, write and read of one packet of data can be performed at the same time in one packet time period, allowing enough memory access time.

With the current state of the art, one chip cannot yet contain five packet memories and therefore several chips should be used. However, a device on which tens-of-megabit internal memories (52-1 through 52-N) have already been made available and packaging density will be increased to a level required for the input buffer with advances in miniaturization technologies.

The packet data read as described above is converted into the transmission data format 620 and the packet data rate is converted into a rate compatible with the high-speed sending IF macro 22 by the rate converter 515. The packet data serialized and speeded in the high-speed sending IF macro 22 of the packet memory 5 is transferred to the high-speed receiving IF macro 21 in the line processing module 3.

The high-speed sending IF macro 22 and high-speed receiving IF macro 21 included in the packet memory 5 and the line processing module 3 are preferably of the same type for matching between their interface characteristics (such as frequencies, basic encode/decode methods, and interface level).

The packet data read from the packet memory 5 is sent to the cross-point switch 6 through the line processing module 3. The cross-point switch 6 has a large selector for selecting packet data for each output route from among all the input lines. The cross-point switch 6 performs switching according to directions from scheduler 4 without discarding packets. The packet data switched is sent back to the line processing module 3, where termination processes are applied to it, then sent to one of the output lines #1 through #N.

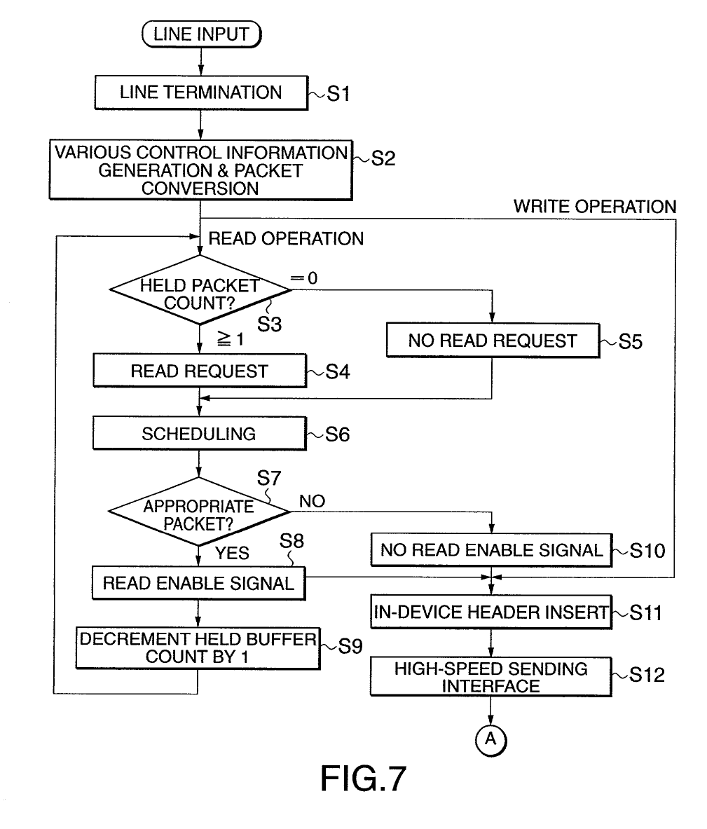

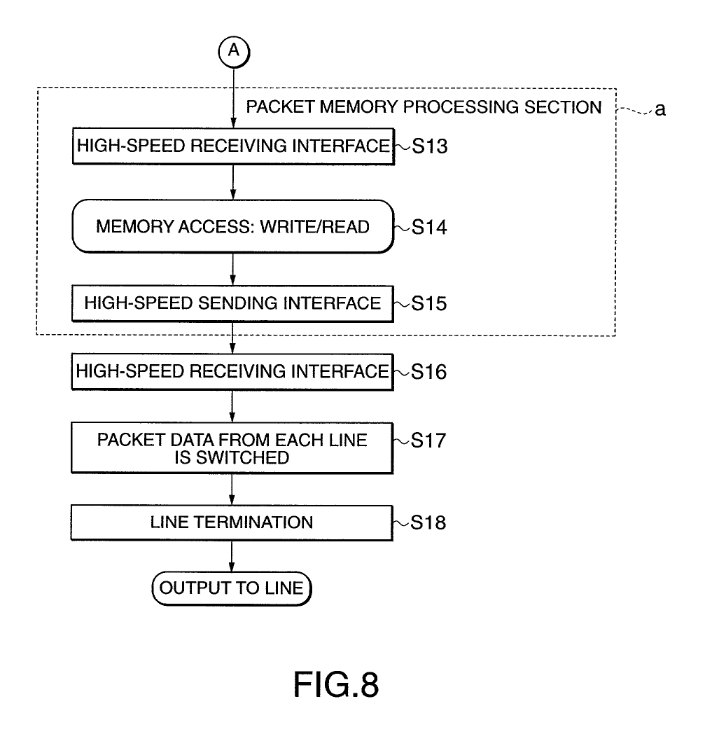

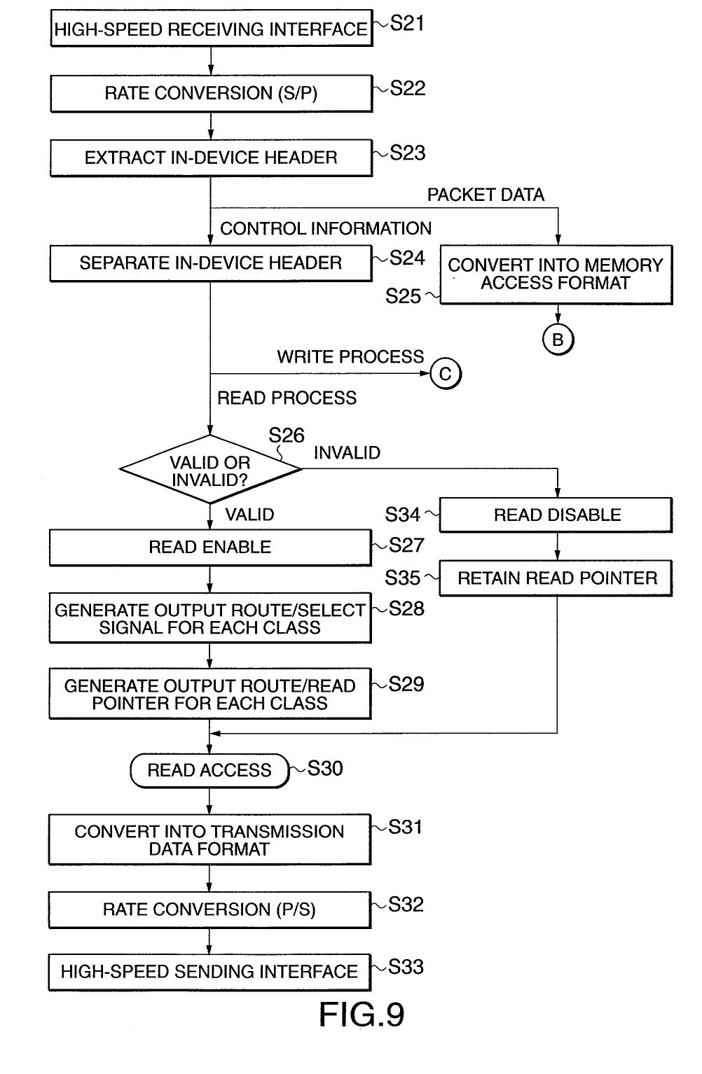

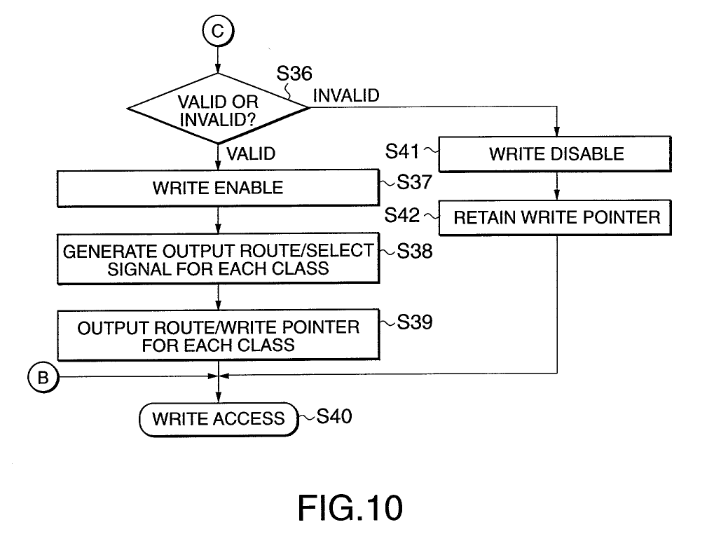

FIGS. 7 and 8 show flowcharts of a control flow in an entire apparatus according to the first embodiment of the present invention. FIGS. 9 and 10 show flowcharts of an internal operation in the packet memory 5 according to the first embodiment of the present invention. The operation of the first embodiment of the present invention will be described below with reference to FIGS. 1 through 10.

In an input-buffer-based packet switch having an N×N structure and a line speed, V, termination processes such as protocol identification, label processing, in-device address translation are applied to packets of different protocols input into the line processing module 3 (step S1 in FIG. 7).

Because some of the packets using different protocols are variable-length packets, such packets are first converted into the in-device fixed-length transmission data format 610. For example, variable-length packet data received is first stored in a memory and then read out at predetermined intervals and converted into fixed-length packet data.

For chopping the packet into fixed-length packets, an area into which in-device address information and control information (which will be describe later) from the scheduler 4 are to be mapped is reserved. Then, address information for individual protocols and the in-device address information are inserted in the header field of the corresponding fixed-length packet (step S11 in FIG. 7).

Once in-device address information conversion is performed in the line processing module 31, in-device address information such as an output route address, class information for each output route, and enable signal indicating whether the packet is valid or not is obtained (step S2 in FIG. 7). The address information is inserted as is in the write header field of the fixed-length packet as control information about the write to the packet memory 5 (step S11 in FIG. 7).

The address information is also used to monitor the number of packets held in the packet memory 5 for each QoS class of each output route (step S3 in FIG. 7). The monitoring can readily be accomplished by using an element such as an up-down counter.

If a count value is larger than or equal to 1 (≧1), then it is determined that one or more packets are stored in the packet memory 5, and a request for a read from the packet memory 5 is sent to the scheduler 4 (step S4 in FIG. 7). If the count value is 0, it is determined that no packets are stored in the packet memory 5, and no read request from the packet memory 5 is issued (step 5 in FIG. 7).

The scheduler 4 has the coordination capability of using bandwidth with minimum wastage in accordance with throughput and knows the packet storage status of each packet memory 5 based on request signals from all of the input lines #1 through #N. The scheduler 4 also performs buffer management for each output link (on a QoS class priority basis) (step S6 in FIG. 7), and if it finds the most appropriate packet (step 7 in FIG. 7), returns a read enable signal to cause the packet to be sent out (step S8 in FIG. 7).

The read enable signal returned from the scheduler 4 to each line processing module 3 through scheduling in this way is converted into address information such as an output route address, class information for each output route, and an enable signal indicating whether the read is valid or invalid, like the address information for the write operation mentioned above. The read enable information is inserted into the read header field of the fixed-length packet as control information about the read from the packet memory 5 (step S11 in FIG. 7).

At this point, the counter value indicating the number of packets held in each packet memory for which the read enable A signal is provided is decremented by one (step S9 in FIG. 7). The packet data to which write and read control information is added is sent to the high-speed sending IF macro 22, where it is converted into a serial signal at several Gbps for each channel (step S12 in FIG. 7). The serialized packet data is sent to the packet memory 5 and undergoes memory access process through the high-speed receiving IF macro 21 in the packet memory 5 (section a in FIG. 8).

An internal operation (section in FIG. 8) within the packet memory 5 according to the present embodiment will be described below with reference to FIGS. 9 and 10.

In the high-speed receiving IF macro 21, data is latched through a CDR function in synchronization with an optimum clock provided by phase adjustment. Then the latched packet data is parallelized and provided to the memory controller 51 (step S13 in FIG. 8 and step S21 in FIG. 9).

In the memory controller 51, the packet data sent from the high-speed receiving IF macro 21 is switched to an internal clock speed suitable for accessing internal memory (step S22 in FIG. 9). Parallel conversion may also be performed at this point. Then an in-device header (write control information and read control information) added to the header field of the packet data is extracted (step S23 in FIG. 9).

The format of the packet data fromwhich the in-device header is extracted is converted into a format for memory access (step S25 in FIG. 9). A data bus width and a word bit width determined here are reflected in the data width in the internal memories 52-1 through 52-N and in the increment of a pointer required for the memory write/read.

The in-device header is separated into write control information and read control information (step S24 in FIG. 9). For write operation, internal memory control signals (a pointer to one of the internal memories 52-1 through 52-N, a write enable signal, and a memory select signal) are generated from the write control information (an output route address, class information for each output route, and an enable signal indicating whether the packet is valid or invalid) extracted from the header field of the packet.

If it is determined from the enable signal, which indicates whether a packet is valid or not, that the packet is valid (step S36 in FIG. 10), a write enable signal is generated (step S37 in FIG. 10). On the other hand, if it is determined from the enable signal that the packet is invalid (step S36 in FIG. 10), a write disable signal is generated (step S41 in FIG. 10). A configuration may be used in which the write enable signal is applied to only a memory of interest selected by using a memory select signal, which will be described below.

Next, a memory select signal for selecting a memory of interest from among the memories separated for each output route/class is generated by decoding the output route address and class information for each output route (step S38 in FIG. 10). An enable signal condition indicating whether the packet is valid or not may be added to the memory select signal.

If the packet is valid, the memory select signal thus obtained and the enable signal indicting whether the packet is valid or not trigger the generation of an address (pointer) for the write to the memory of interest (step s39 in FIG. 10). On the other hand, if the packet is invalid, the address (pointer) for the write to the memory of interest is retained (step S42 in FIG. 10).

Because the internal memories 52-1 through 52-N are FIFO memories, a write address (pointer) counter is incremented in synchronization with a clock when the write of the packet to the internal memories 52-1-52-N is indicated. The counter value is incremented by a number equivalent to the bit width of the packet data word in every packet cycle. The write operation of the packet to the internal packet memories 52-1 through 52-N is performed under the control of internal memory control signals obtained (step S14 in FIG. 8 and step S40 in FIG. 10).

During the write to one of the internal memories 52-1 through 52-N (step S40 in FIG. 10), the packet data converted into packet data for memory access is sent to that one of the internal memories 52-1 through 52-N together with the internal memory control signals generated from the header added to the packet data in the same cycle.

The memory to which the packet data is written is selected according to the memory select signal. If it is determined that the packet data is valid, the write enable signal directs the write. Then, write operation to the memory is performed according to the pointer, which is incremented with a clock cycle. On the other hand, if it is determined that the packet data is is invalid, the direction by the write enable signal does not take place and the write operation to the memory is not performed.

The process for read operation is essentially the same as that for the write operation. Internal memory control signals (a pointer to one of the internal memories 52-1 through 52-N, a read enable signal, and memory select signal) are generated from read control information (an output route address, class information for each output route, and read enable signal) extracted from the header field of packet data.

If it is determined that the packet data is valid based on an enable signal indicating whether a packet is valid or not (step S26 in FIG. 9), a read enable signal is generated (step S27 in FIG. 9). On the other hand, if it is determined by the enable signal that the packet is invalid (step S26 in FIG. 9), a read disable signal is generated (step S34 in FIG. 9). A configuration may be used in which the read enable signal is applied only to amemory selected by using a memory select signal, which will be described below.

Next, the output route address and class information for the output route are decoded to generate a memory select signal for selecting a memory of interest from among the memories separated for each output route/class (step S28 in FIG. 9). The condition of the read enable signal may be added to the memory select signal.

If the read is allowed, the memory select signal thus obtained and the read enable signal trigger the generation of an address (pointer) for the read from amemory of interest (step S29 in FIG. 9). On the other hand, if the read is not allowed, the read address (pointer) to the memory of interest is retained (step S35 in FIG. 9).

Because the internal memories 52-1 through 52-N are FIFO memories, a read address (pointer) counter is incremented in synchronization with a clock when the read from the internal memories 52-1-52-N is indicated. The counter value is incremented by a number equivalent to the bit width of the packet data word in every packet cycle. The read operation of the packet from one of the internal packet memories 52-1 through 52-N is performed under the control of internal memory control signals obtained (step S30 in FIG. 9).

During the read operation from the internal memories 52-1 through 52-N (step S30 in FIG. 9), the internal memory control signals generated from the header added to the packet data are sent to the corresponding one of the memories 52-1 through 52-N. The memory of interest is selected by using the memory select signal. If it is determined that the read is allowed, the read enable signal indicates the read of the packet data. Then the read operation form the memory of interest is perf ormed according to the pointer, which is incremented with a clock cycle. On the other hand, if it is determined that the read is not allowed, the indication of the read by the read enable signal does not occur and the read from the memory of interest is not performed. The write and read operations for the internal memories 52-1 through 52-N described above can be performed at the same time.

In the foregoing description, it is assumed that the internal memories 52-1 through 52-N are physically divided according to classes of individual output routes. If they are logically divided according to output routes or classes, the process for generating a memory select signal and read/write address pointer is modified so that individual classes are identified by a high-order-bit of a pointer. If the internal memories 52-1 through 52-N are divided logically, the number of the memories is reduced and therefore the number of wires in a chip can be advantageously reduced.

The packet data read from the internal memories 52-1 through 52-N is converted into a transmission data format (step S31 in FIG. 9). Then the speed of the convertedpacket data is converted into the clock speed compatible with the high-speed sending IF macro 22 (step S32 in FIG. 9). Serial conversion may be performed at this point if required.

Then the packet data is sent to the high-speed sending IF macro 22, where it is converted into serial data (step S15 in FIG. 8 and step S33 in FIG. 9). The serialized packet data is transferred to the high-speed receiving IF macro 21 of the line processing module 3, where it is latched for phase adjustment and parallelized (step S16 in FIG. 8).

The packet data from the line processing module 3 is switched by the cross-point switch 6 according to a direction form the scheduler 4 without causing collision (blocking) (step S17 in FIG. 8). The switched packet data is sent back to the line processing module 3, where line termination processes such as header processing of the in-device packet and packet assembling for various protocols are performed (step S18 in FIG. 8), then it is sent out to one of the output lines #1 through #N.

Because of the characteristics of an input-buffer-based packet switch, the rate of storing a packet in the internal memories 52-1 through 52-N and the rate of packet transfer from each of the internal memories 52-1 through 52-N to each of the output links are the same as the rate of packet transfer over an input link. This means that the access speed for storing a packet in a memory increases with an increase in line speed.

The present invention enables serial transmission ofpacket data to the packet memory 5, instead of conventional parallel transmission, by providing the high-speed sending and receiving interface circuits in the line processing module 3 and packet memory 5 provided on separate chips and by transmitting the packet data at high speed. This enables the reduction in the number of terminals and therefore pins of a chip case and the number of package layers in installation and also the size of components such as a connector. That is, the present invention is capable of adapting to a growth in capacity of a switch in terms of installation. In addition, the speed of lines and line processing module 3 can be increased by extending the high-speed access to the packet memory 5.

While the method in which control signals for accessing the packet memory 5 are mapped into the header field of packet data has been described with respect to the present embodiment, the write/read control signals may be defined and transmitted over a signal line provided separately from a line over which the packet data is transmitted.

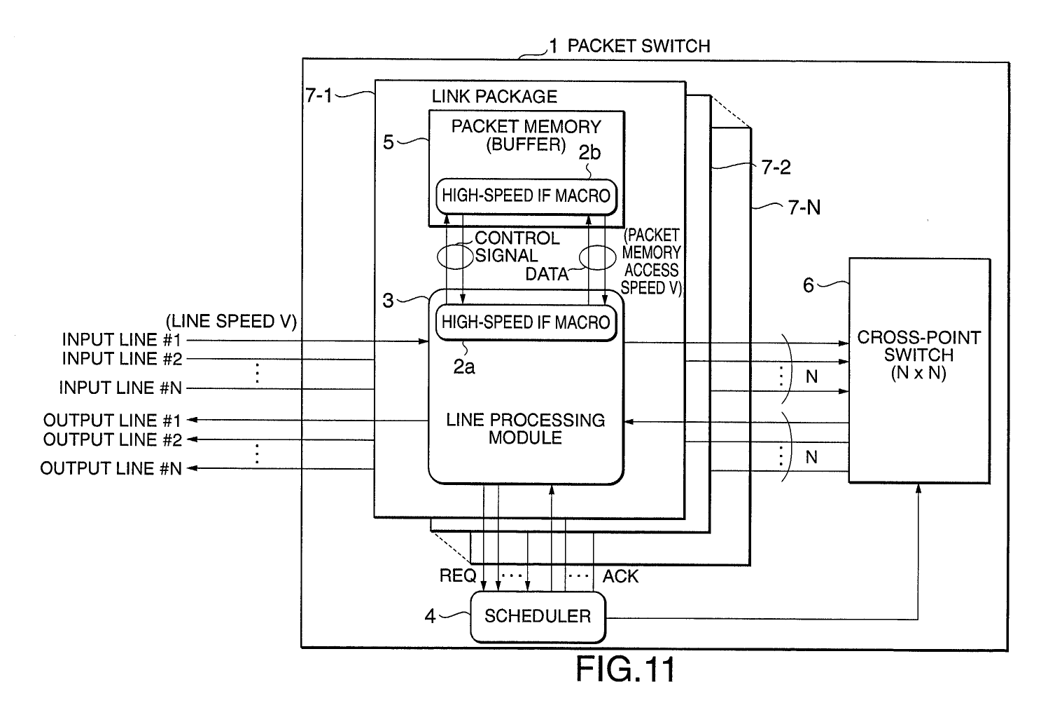

FIG. 11 shows a block diagram of a configuration of a packet switch according to a second embodiment of the present invention. The configuration of the packet switch in FIG. 11 according to the second embodiment of the present invention is the same as that of the packet switch 1 according to the first embodiment of the present invention shown in FIG. 1, except that a line for transmitting write/read control signals to a packet memory 5 is provided separately from a line for transmitting packet data. The same components in FIG. 11 as those in the FIG. 1 are therefore labeled with the same reference numbers in FIG. 1.

In the second embodiment of the present invention, the number of accesses to the packet memory 5 increases by the number of write/read control signals. However, the data field of a fixed-length packet is increased proportionally. If the transfer rate to the packet memory 5 is the same, the amount of data transmitted in one packet cycle can be increased accordingly.

The configuration of the second embodiment of the present invention enables the reduction of functions (circuits) such as the insertion and extraction of control signals in the header field of a packet data, thereby increasing processing speed.

While packet data read from the packet memory 5 is sent back to the line processing module 3 in the first embodiment of the present invention, the packet data read from the packet memory 5 may be transferred directly to the cross-point switch 6.

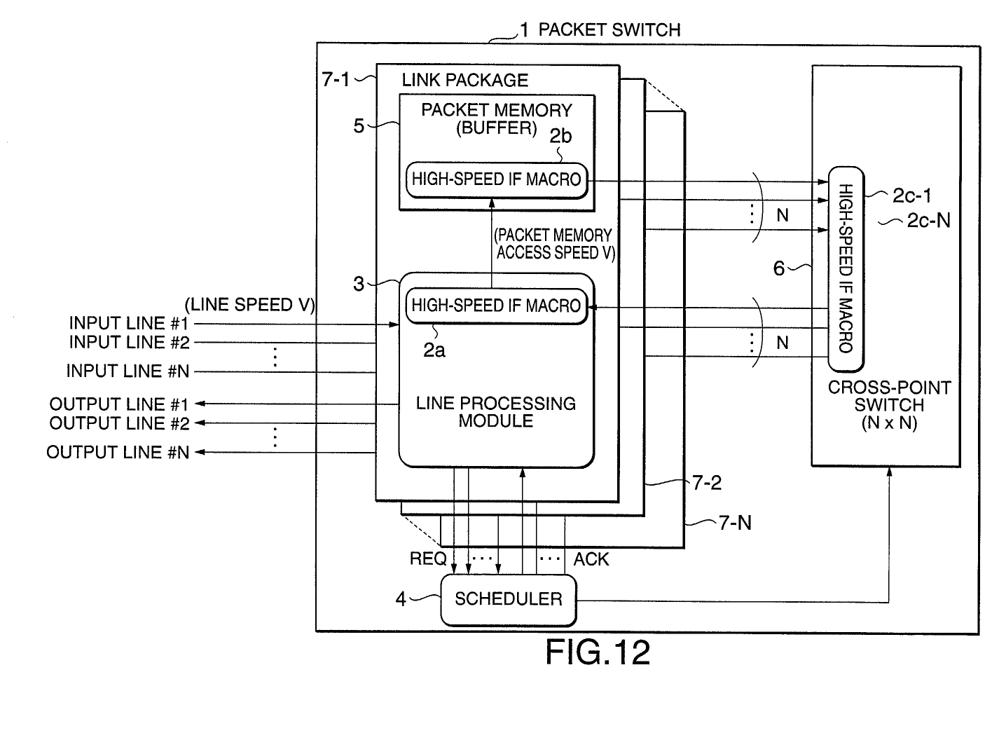

FIG. 12 shows a block diagram of a configuration of a packet switch according to a third embodiment of the present invention. The packet switch according to the third embodiment of the present invention in FIG. 12 transfers packet data read from a packet memory 5 directly to a cross-point switch 6. The configuration of the packet switch in the third embodiment of the present invention is the same as that of the packet switch 1 according to the first embodiment of the present invention shown in FIG. 1, except that the packet is transferred from the cross-point switch 6 to a line processing module 3. The same components in FIG. 12 as those in the FIG. 1 are therefore labeled with the same reference numbers in FIG. 1.

In the third embodiment of the present invention, a high-speed IF macro 2a is provided in the line processing module 3, a high-speed IF macro 2b is provided in the packet memory 5, and high-speed IF macros 2c-1 through 2c-N are provided in the cross-point switch 6. As a result, the number of connections between the line processing module 3 and the packet memory 5, the number of connections between the packet memory 5 and the cross-point switch 6, and the number of connections between the cross-point switch 6 and the line processing module 3 can be reduced. The reduction is more drastic in a packet switch having more transmission lines installed. As a result, the transmission process of packet data from the packet memory 5 to the line processing module 3 and the transmission process of packet data from the line processing module 3 to the cross-point switch 6 can be eliminated. Thus, on the whole, the number of signal lines on a circuit board is reduced and the number of package layers can be further reduced.

While a relatively low speed interface is used between the line processing module 3 and the scheduler 4 in the first embodiment of the present invention, it may be a high-speed sending/receiving interface.

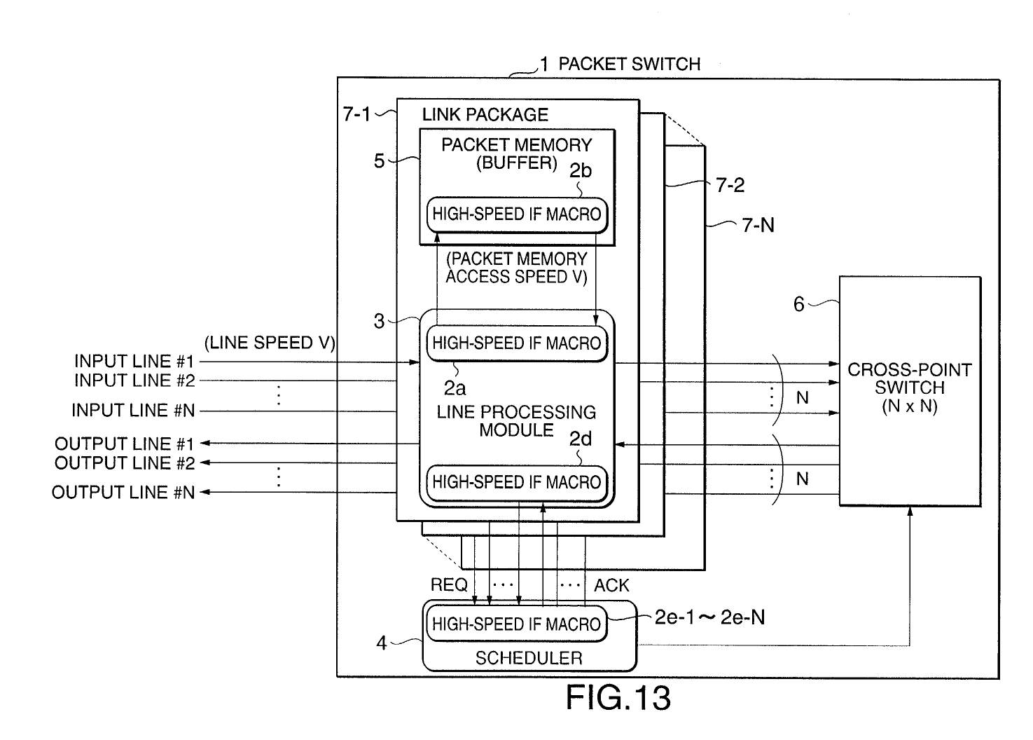

FIG. 13 shows a block diagram of a configuration of a packet switch according to a fourth embodiment of the present invention. The configuration of the packet switch 1 according to the fourth embodiment of the present invention in FIG. 13 is the same as that of the packet switch 1 according to the first embodiment of the present invention shown in FIG. 1, except that high-speed interfaces are used between line processing modules 3 and a scheduler 4. The same components in FIG. 13 as those in the FIG. 1 are therefore labeled with the same reference numbers in FIG. 1.

Essentially, read request signals and read enable signals for all packet memories 52-1 through 52-N should be transmitted between line processing modules 3 and the scheduler 4. Each of the packet memories 52-1 through 52-N is provided for each output route/QoS class for each of input lines #1 through #N. Transmitting packet data to and from the packet memories 52-1 through 52-N individually would require a larger number of terminals.

In order to reduce the number of terminals, the request signals and read enable signals of each output route/QoS class for each of the input lines #1 through #N are typically multiplexed together to transmit over one line. However, all of the request signals and read enable signals must be multiplexed in one packet period. Therefore, the number of lines that can be installed would become small due to the fixed length of packets and frequencies if low-speed interfaces were used.

Therefore, in the fourth embodiment of thepresent invention, a high-speed IF macros 2d, 2e-1 through 2e-N are provided in the line processing modules 3 and scheduler 4 to increase interface speed. This allows more regions to be provided in which request signals and read enable signals are multiplexed and more lines to be supported. As a result, a larger packet switch can be realized.

The second through fourth embodiments of the present invention can be implemented separately or combined, and the present invention is not limited to these embodiments.

The present invention provides the following advantages. In a packet switch that stores packet data in a packet memory for each output link on an input-line basis and transfers the packet data from the packet memory to a lower loaded output link, in-device address translation can be applied to the packet data to obtain at least packet memory write/read control signals. In addition, the packet data is stored in the packet memory through first high-speed interface unit for sending and receiving the packet data at high speed based on the write/read control signals to enables fast access to the packet memory without increasing the number of terminals. Thus, the present invention has an advantage that the speed of lines and line processing modules can be increased.

While the present invention has been described in connection with certain preferred embodiments, it is to be understood that the subject matter encompassed by way of this invention is not limited to those specific embodiments. On the contrary it is intended for the subject matter of the invention to include all alternatives, modifications, and equivalents as can be included within the spirit and scope of the following claims.

What is claimed is:

1. A packet switch comprising:
a packet memory for storing packet data for each of output links on an input-line basis;
line processing unit for performing in-device address conversion of said packet data to obtain at least write/read control signals for said packet memory; and
first high-speed interface unit provided in each of said packet memory and said line processing unit for sending and receiving at least said packet data at high speed;
wherein said packet data is stored in said packet memory through said first high-speed interface unit based on said write/read control signals obtained by said line processing unit.

2. The packet switch according to claim 1, further comprising:
scheduling unit for scheduling the read of said packet data from said packet memory; and
unit for communicating information about said in-device address translation for all input lines that is obtained on an input-line basis to said scheduling unit,
wherein packet memory control is performed for each of said output links according to scheduling by said scheduling unit to read said packet data from said packet memory through said first high-speed interface unit.

3. The packet switch according to claim 1, further comprising: unit for converting the format of said packet data into a format for said packet memory when said packet data is written into said packet memory; and
unit for writing said format-converted packet data into said packet memory based on said write control signal.

4. The packet switch according to claim 2, further comprising:
unit for converting the format of said packet data into a format for said packet memory when said packet data is written into said packet memory; and
unit for writing said format-converted packet data into said packet memory based on said write control signal.

5. The packet switch according to claim 1, further comprising unit for reading said packet data from said packet memory according to said read control signal during the read from said packet memory.

6. The packet switch according to claim 2, further comprising unit for reading said packet data from said packet memory according to said read control signal during the read from said packet memory.

7. The packet switch according to claim 3, further comprising unit for reading said packet data from said packet memory according to said read control signal during the read from said packet memory.

8. The packet switch according to claim 4, further comprising unit for reading said packet data from said packet memory according to said read control signal during the read from said packet memory.

9. The packet switch according to claim 1, wherein said line processing unit inserts said write/read control signals in said packet data to transmit said control signals and said packet data to said packet memory.

10. The packet switch according to claim 9, further comprising unit for extracting said write/read control signals from said packet data transferred to said packet memory through said first high-speed interface unit.

11. The packet switch according to claim 2, further comprising second high-speed interface unit provided in said line processing unit and said scheduling unit for sending and receiving at least information about said in-device address translation at high speed, wherein said information about said in-device address translation for all of said lines is communicated to said scheduling unit through said second high-speed interface unit.

12. The packet switch according to claim 3, further comprising second high-speed interface unit provided in said line processing unit and said scheduling unit for sending and receiving at least information about said in-device address translation at high speed, wherein said information about said in-device address translation for all of said lines is communicated to said scheduling unit through said second high-speed interface unit.

13. The packet switch according to claim 5, further comprising second high-speed interface unit provided in said line processing unit and said scheduling unit for sending and receiving at least information about said in-device address translation at high speed, wherein said information about said in-device address translation for all of said lines is communicated to said scheduling unit through said second high-speed interface unit.

14. The packet switch according to claim 9, further comprising second high-speed interface unit provided in said line processing unit and said scheduling unit for sending and receiving at least information about said in-device address translation at high speed, wherein said information about said in-device address translation for all of said lines is communicated to said scheduling unit through said second high-speed interface unit.

15. The packet switch according to claim 10, further comprising second high-speed interface unit provided in said line processing unit and said scheduling unit for sending and receiving at least information about said in-device address translation at high speed, wherein said information about said in-device address translation for all of said lines is communicated to said scheduling unit through said second high-speed interface unit.

16. The packet switch according to claim 1, wherein said first high-speed interface unit sending and receiving said packet data and said write/read control signals over respective separate signal lines.

17. The packet switch according to claim 1, further comprising: switching unit for switching said packet data; and third high-speed interface unit provided in said packet memory and said switching unit for sending and receiving said packet data at high speed,
wherein said packet data read from said packet memory is transferred to said switching unit through said third high-speed interface unit.

18. The packet switch according to claim 2, further comprising: switching unit for switching said packet data: and third high-speed interface unit provided in said packet memory and said switching unit for sending and receiving said packet data at high-speed,
wherein said packet data read from said packet memory is transferred to said switching unit through said third high-speed interface unit.

19. The packet switch according to claim 3, further comprising switching unit for switching said packet data; and third high-speed interface unit provided in said packet memory and said switching unit for sending and receiving said packet data at high-speed,
wherein said packet data read from said packet memory is transferred to said switching unit through said third high-speed interface unit.

20. The packet switch according to claim 5, further comprising switching unit for switching said packet data; and third high-speed interface unit provided in said packet memory and said switching unit for sending and receiving said packet data at high-speed,
wherein said packet data read from said packet memory is transferred to said switching unit through said third high-speed interface unit.

21. The packet switch according to claim 9, further comprising switching unit for switching said packet data; and third high-speed interface unit provided in said packet memory and said switching unit for sending and receiving said packet data at high-speed,
wherein said packet data read from said packet memory is transferred to said switching unit through said third high-speed interface unit.

22. The packet switch according to claim 10, further comprising switching unit for switching said packet data; and third high-speed interface unit provided in said packet memory and said switching unit for sending and receiving said packet data at high-speed,
wherein said packet data read from said packet memory is transferred to said switching unit through said third high-speed interface unit.

23. The packet switch according to claim 11, further comprising switching unit for switching said packet data; and third high-speed interface unit provided in said packet memory and said switching unit for sending and receiving said packet data at high-speed,
wherein said packet data read from said packet memory is transferred to said switching unit through said third high-speed interface unit.

24. The packet switch according to claim 16, further comprising switching unit for switching said packet data; and third high-speed interface unit provided in said packet memory and said switching unit for sending and receiving said packet data at high-speed,
wherein said packet data read from said packet memory is transferred to said switching unit through said third high-speed interface unit.

25. The packet switch according to claim 17, wherein each of said first, second, and third high-speed interface unit includes a CDR (Clock and Data Recovery) functions for obtaining an optimum clock from received data to latch said data with said clock.

26. A packet memory access method for a packet memory storing packet data for each of output links on input-line basis, comprising the steps of:
performing in-device address conversion of said packet data to obtain at least write/read control signals for said packet memory; and
storing said packet data in said packet memory through first high-speed interface unit that sends and receives at least said packet data at high speed based on said write/read control signals.

27. The packet memory access method according to claim 26, further comprising the step of communicating information about said in-device address translation for all of the input lines obtained on an input-line basis to scheduling unit that schedules the read of said packet data from said packet memory,
wherein packet memory control is performed for each of said output links according to scheduling by said scheduling unit to read said packet data from said packet memory through said first high-speed interface unit.

28. The packet memory access method according to claim 26, further comprising the steps of:
converting the format of said packet data into a format for said packet memory when said packet data is written into said packet memory; and
writing said format-converted packet data into said packet memory based on said write control signal.

29. The packet memory access method according to claim 27, further comprising the steps of:
converting the format of said packet data into a format for said packet memory when said packet data is written into said packet memory; and
writing said format-converted packet data into said packet memory based on said write control signal.

30. The packet memory access method according to claim 26, further comprising the steps of:
reading said packet data from said packet memory according to said read control signal during the read from said packet memory.

31. The packet memory access method according to claim 27, further comprising the step of reading said packet data from said packet memory according to said read control signal during the read from said packet memory.

32. The packet memory access method according to claim 28, further comprising the step of reading said packet data from said packet memory according to said read control signal during the read from said packet memory.

33. The packet memory access method according to claim 29, further comprising the step of reading said packet data from said packet memory according to said read control signal during the read from said packet memory.

34. The packet memory access method according to claim 26, wherein said write/read control signals are inserted into said packet data and sent to said packet memory.

35. The packet memory access method according to claim 34, further comprisingthe step of extracting said write/read control signal from said packet data transferred to said packet memory through said first high-speed interface unit.

36. The packet memory access method according to claim 27, wherein information about said in-device address translation for all of the lines is communicated to said scheduling unit through second high-speed interface unit that sends and receives at least said information about said in-device address translation at high speed.

37. The packet memory access method according to claim 28, wherein information about said in-device address translation for all of the lines is communicated to said scheduling unit through second high-speed interface unit that sends and receives at least said information about said in-device address translation at high speed.

38. The packet memory access method according to claim 30, wherein information about said in-device address translation for all of the lines is communicated to said scheduling unit through second high-speed interface unit that sends and receives at least said information about said in-device address translation at high speed.

39. The packet memory access method according to claim 34, wherein information about said in-device address translation for all of the lines is communicated to said scheduling unit through second high-speed interface unit that sends and receives at least said information about said in-device address translation at high speed.

40. The packet memory access method according to claim 35, wherein information about said in-device address translation for all of the lines is communicated to said scheduling unit through second high-speed interface unit that sends and receives at least said information about said in-device address translation at high speed.

41. The packet memory access method according to claim 26, wherein said first high-speed interface unit sends and receives said packet data and said write/read control signals over respective separate signal lines.

42. The packet memory access method according to claim 26, wherein said packet data read from said packet memory is transferred to switching unit for switching said packet data through third high-speed interface unit that sends and receives said packet data at high speed.

43. The packet memory access method according to claim 27, wherein said packet data read from said packet memory is transferred to switching unit for switching said packet data through third high-speed interface unit that sends and receives said packet data at high speed.

44. The packet memory access method according to claim 28, wherein said packet data read from said packet memory is transferred to switching unit for switching said packet data through third high-speed interface unit that sends and receives said packet data at high-speed.

45. The packet memory access method according to claim 30, wherein said packet data read from said packet memory is transferred to switching unit for switching said packet data through third high-speed interface unit that sends and receives said packet data at high-speed.

46. The packet memory access method according to claim 34, wherein said packet data read from said packet memory is transferred to switching unit for switching said packet data through third high-speed interface unit that sends and receives said packet data at high-speed.

47. The packet memory access method according to claim 35, wherein said packet data read from said packet memory is transferred to switching unit for switching said packet data through third high-speed interface unit that sends and receives said packet data at high-speed.

48. The packet memory access method according to claim 36, wherein said packet data read from said packet memory is transferred to switching unit for switching said packet data through third high-speed interface unit that sends and receives said packet data at high-speed.

49. The packet memory access method according to claim 41, wherein said packet data read from said packet memory is transferred to switching unit for switching said packet data through third high-speed interface unit that sends and receives said packet data at high-speed.

50. The packet memory access method according to claim 42, wherein each of said first, second, and third high-speed interface unit includes a CDR (Clock and Data Recovery) function for obtaining an optimum clock from received data to latch said data with said clock.
